(19) United States
(12) Patent Application Publication
(10) Pub. No.: US 2016/0316233 A1
(43) Pub. Date: Oct. 27, 2016

(54) SYSTEM AND METHOD FOR INSERTING, DELIVERING AND TRACKING ADVERTISEMENTS IN A MEDIA PROGRAM

(71) Applicant: ADSPARX USA INC, Dover, DE (US)

(72) Inventors: Lilesh Sharad Ghadi, Mumbai (IN); Ketan Avinash Barhate, Thane (IN); Kunal Janardan Lagwankar, Thane (IN)

(21) Appl. No.: 14/882,960

(22) Filed: Oct. 14, 2015

(30) Foreign Application Priority Data
Apr. 21, 2015 (IN) 2046/CHE/2015

(51) Int. Cl. H04N 21/234; H04N 21/858; H04N 21/845; G11B 27/10; H04N 21/4402; H04N 21/262; H04N 21/458; H04N 21/242; H04N 21/43; H04N 21/81; H04N 21/231

(52) U.S. Cl. CPC H04N 21/23424; H04N 21/812; H04N 21/8586; H04N 21/8456; G11B 27/10; H04N 21/23109; H04N 21/26258; H04N 21/262; H04N 21/458; H04N 21/242; H04N 21/4302; H04N 21/440218

(57) ABSTRACT

A method for inserting advertisements into a media program and tracking a delivery of the advertisements is provided. The method includes the following steps: (i) generating a request for the media program; (ii) receiving the request from a user device for retrieving a plurality of advertisements; (iii) obtaining a start time and an end time of a plurality of advertisement slots associated with the media program; (iv) selecting advertisements for delivering at the plurality of advertisement slots within the media program; (v) splitting the media program into a plurality of sub-programs; (vi) splitting the advertisements into a plurality of ad chunks; (vii) creating an URL playlist by stitching URL's of the plurality of sub-programs with URL's of the plurality of ad chunks at the plurality of advertisement slots; and (viii) obtaining the URL playlist to fetch and play content associated with each URL in the URL playlist sequentially.

This application claims priority to Indian patent application no. 2046/CHE/2015 filed on Apr. 21, 2015, the complete disclosure of which, in its entirety, is herein incorporated by reference.

### BACKGROUND

1. Technical Field

The embodiments herein generally relate to an advertisement management system, and, more particularly, a system and method for inserting, tracking, delivering advertisements in a pre-roll and a mid-roll of a media program.

2. Description of the Related Art

The spread of the Internet and the general availability of data connections are changing the way media is provided and used. In particular, conventional television and/or radio services are increasingly giving way to digital network-based streaming media on demand and/or live streaming media. Such streaming media content can be delivered through any digital network, such as a cable company's set top box-based network or a cellular data network, or increasingly, through the Internet. The delivery can be to any suitable rendering device, such as an Apple TV or an Xbox 360, connected to a television or monitor, or can be to a rendering device and display, such as an Internet TV or a mobile device, such as player software executing on an Apple iPad, a laptop computer, a mobile phone, etc.

A common technique of inserting additional content, typically advertising, into a live media stream is called “splicing”. Splicing involves replacing some of the media content segments in a live media stream with new content. For example, during a live sporting event, such as tennis, the players take breaks between each game or between sets. These breaks in the play are opportunities to present advertising to viewers. Even though there are few typical approaches that attempts to insert advertisements, there remains a need for an efficient system and method for inserting, delivering, and tracking advertisements in a video streaming.

### SUMMARY

In view of the foregoing, an embodiment herein provides a system for inserting advertisements into a media program and tracking a delivery of the advertisements. The system includes a user device, an advertisement manager, a streaming server, and a manifest server. The user device generates a request for the media program. The advertisement manager receives the request from the user device for retrieving one or more advertisements. The advertisement manager includes an advertisement slots obtaining module, and an advertisements selecting module. The advertisement slots obtaining module, executed by a processor of the advertisement manager, obtains start time and end time of one or more advertisement slots associated with the media program. The advertisements selecting module, executed by the processor, selects advertisements for delivering at the one or more advertisement slots within the media program. The streaming server splits the media program into one or more sub-programs of predetermined durations. Each of the one or more sub-programs includes an associated uniform resource locator (URL). The streaming server splits the advertisements into one or more ad chunks of predetermined durations. Each of the one or more ad chunks includes an associated uniform resource locator (URL). The manifest server creates a URL playlist by stitching URL's of the one or more sub-programs with URL's of the one or more ad chunks at the advertisement slots. The user device a) obtains the URL playlist from the manifest server, and b) fetches and plays content associated with each URL in the URL playlist sequentially.

In one embodiment, the manifest server (a) downloads at least a part of a first sub-program of the one or more sub-programs, (b) extracts a starting timestamp associated with the first sub-program, and (c) communicates the starting time of the first sub-program to the advertisement manager for selecting an advertisement that includes streaming at the starting time to ensure a smooth transition from the advertisement to the first sub-program. In another embodiment, the starting timestamp includes (a) a decode timestamp or a presentation timestamp which is extracted from a video packet of the first sub-program, or (b) a presentation clock reference which is extracted from an audio packet of the first sub-program. In yet another embodiment, the manifest server (a) downloads at least a part of each of the one or more sub-programs, (b) extracts a starting timestamp associated with each of the one or more sub-programs, (c) obtains a start time and an end time of an advertisement slot associated with the media program from the advertisement manager, and (d) creating the URL playlist by replacing a sub-program URL corresponding to a sub-program which is about to stream at the advertisement slot with at least one ad chunk URL. In yet another embodiment, the starting timestamp includes (a) a decode timestamp or a presentation timestamp which is extracted from a video packet of each of the one or more sub-programs, or (b) a presentation clock reference which is extracted from an audio packet of each of the one or more sub-programs. The manifest server further (a) stitches the URL associated with the one or more advertisements first followed by the URL associated with the media program to create the URL playlist, and (b) stitches URLs associated with advertisements in between URLs associated with program content to create the URL playlist. In yet another embodiment, the streaming server splits the sub-program into a first split sub-program and a second split sub-program when the advertisement slot starts or ends in between a start time and an end time of the sub-program. In yet another embodiment, the manifest server further (a) adds an URL corresponding to the first split sub-program to the URL playlist, and (b) replaces an URL corresponding to the second split sub-program with the at least one ad chunk URL. In yet another embodiment, the manifest server further (a) replaces an URL corresponding to the first split sub-program with the at least one ad chunk URL, and (b) adds a URL corresponding to the second split sub-program to the URL playlist. In yet another embodiment, the user device further includes a SDK for tracking delivery and viewing of the advertisements at the user device. The SDK is triggered based on an ID3 packet inside the one or more ad chunks at various locations corresponding to at least one of (a) start, (b 25%, (c) 50%, (d) 75%, and (e) 100% duration of the advertisements. In yet another embodiment, the ID3 packet is inserted to the one or more ad chunks by an advertisement delivery server while transcoding the advertisements. In yet another embodiment, the manifest server creates the URL playlist by stitching the tracker URLs along with URLs of the ad chunk at the advertisement slots. The user device requests a tracker URL when a part of the media program is played back on the user device. In yet another embodiment, the selected advertisements are delivered at the one or more advertisement slots within the media program through the streaming server instead of the advertisement manager. The selected advertisements are cached for one or more users on the one or more same advertisement slots with same target parameters.

In another aspect, a computer implemented method of inserting advertisements into a media program and tracking a delivery of the advertisements is provided. The method includes the following steps: (i) generating a request for the media program, (ii) receiving the request from a user device for retrieving one or more advertisements, (iii) obtaining a start time and an end time of one or more advertisement slots associated with the media program, (iv) selecting advertisements for delivering at the one or more advertisement slots within the media program, (v) splitting the media program into one or more sub-programs of predetermined durations, (vi) splitting the advertisements into one or more ad chunks of predetermined durations, (vii) creating an URL playlist by stitching URL's of the one or more sub-programs with URL's of the one or more ad chunks at the one or more advertisement slots, and (viii) obtaining the URL playlist by the user device to fetch and play content associated with each URL in the URL playlist sequentially. In one embodiment, each of the one or more sub-programs includes an associated uniform resource locator (URL). In another embodiment, each of the one or more ad chunks includes an associated uniform resource locator (URL).

In one embodiment, the method further includes the following steps: (i) downloading at least a part of a first sub-program of the one or more sub-programs, (ii) extracting a starting times tamp associated with the first sub-program, and (iii) communicating the starting time of the first sub-program to the advertisement manager for selecting an advertisement that completes streaming at the starting time to ensure a smooth transition from the advertisement to the first sub-program. In another embodiment, the starting timestamp includes (a) a decode timestamp or a presentation timestamp which is extracted from a video packet of the first sub-program, or (b) a presentation clock reference which is extracted from an audio packet of the first sub-program. In yet another embodiment, the method further includes the following steps: (i) downloading at least a part of each of the one or more sub-programs, (ii) extracting a starting timestamp associated with each of the one or more sub-programs, (iii) obtaining a start time and an end time of an advertisement slot associated with the media program from the advertisement manager, and (iv) creating the URL playlist by replacing a sub-program URL corresponding to a sub-program which is about to stream at the advertisement slot with at least one ad chunk URL. In yet embodiment, the starting timestamp includes (a) a decode timestamp or a presentation timestamp which is extracted from a video packet of each of the one or more sub-programs, or (b) a presentation clock reference which is extracted from an audio packet of each of the one or more sub-programs. In yet another embodiment, the method further includes the following steps: (i) stitching the URL associated with the one or more advertisements first followed by the URL associated with the media program to create the URL playlist, and (ii) stitching URLs associated with advertisements in between URLs associated with program content to create the URL playlist. In yet another embodiment, the method further includes the step of splitting the sub-program into a first split sub-program and a second split sub-program when the advertisement slot starts and ends in between a start time and an end time of the sub-program. In yet another embodiment, the method further includes the following steps: (i) adding a URL corresponding to the first split sub-program to the URL playlist, and (ii) replacing a URL corresponding to the second split sub-program with the at least one ad chunk URL.

In yet another aspect, a non-transitory program storage device readable by computer, and includes a program of instructions executable by the computer to perform a method for inserting advertisements into a media program and tracking a delivery of the advertisements is provided. The method includes following steps: (i) generating a request for the media program, (ii) receiving the request from a user device for retrieving one or more advertisements, (iii) obtaining a start time and an end time of one or more advertisement slots associated with the media program, (iv) selecting advertisements for delivering at the one or more advertisement slots within the media program, (v) splitting the media program into one or more sub-programs of predetermined durations, (vi) splitting the advertisements into one or more ad chunks of predetermined durations, (vii) creating an URL playlist by stitching URL's of the one or more sub-programs with URL's of the one or more ad chunks at the one or more advertisement slots, and (viii) obtaining the URL playlist by the user device to fetch and play content associated with each URL in the URL playlist sequentially. In one embodiment, each of the one or more sub-programs includes an associated uniform resource locator (URL). In another embodiment, each of the one or more ad chunks includes an associated uniform resource locator (URL).

In yet another embodiment, the method further includes the following steps: (i) downloading at least a part of a first sub-program of the one or more sub-programs, (ii) extracting a starting timestamp associated with the first sub-program, (iii) communicating the starting time of the first sub-program to the advertisement manager for selecting an advertisement that completes streaming at the starting time to ensure a smooth transition from the advertisement to the first sub-program. In yet another embodiment, the starting timestamp includes (a) a decode timestamp or a presentation timestamp which is extracted from a video packet of the first sub-program, or (b) a presentation clock reference which is extracted from an audio packet of the first sub-program.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of an advertisement inserting and tracking system according to an embodiment herein;

FIG. 2 illustrates the advertisement inserting and tracking system of FIG. 1 for tracking delivery and playback of advertisements according to an embodiment herein;

FIG. 3 illustrates an exploded view of an advertisement manager of FIG. 1 according to an embodiment herein;

FIGS. 4A and 4B are an exemplary table views illustrating splitting a program content and an advertisement content of FIG. 1 according to an embodiment herein;

FIG. 5 is a table view illustrating inserting a mid-roll advertisement content into a program content of FIG. 1 according to an embodiment herein;

FIG. 6 is a table view illustrating inserting a pre-roll advertisement content into a program content of FIG. 1 according to an embodiment herein;

FIG. 7 is a table view illustrating inserting a post-roll advertisement content into a program content of FIG. 1 according to an embodiment herein;

FIG. 8 is a flow diagram illustrating a method of inserting an advertisement into a program content and tracking a delivery of the advertisement using the advertisement inserting and tracking system of FIG. 1 according to an embodiment herein; and

FIG. 9 illustrates a schematic diagram of a computer architecture in accordance to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

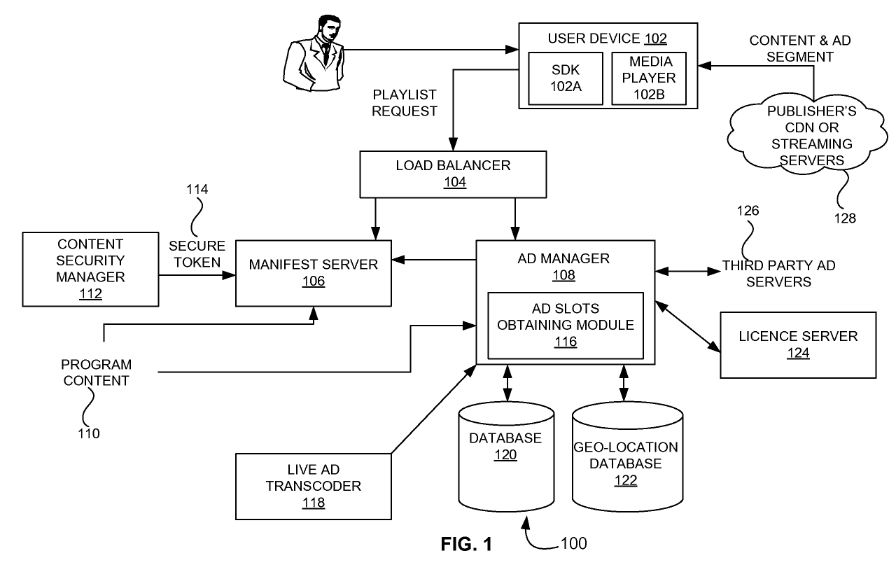

As mentioned, there remains a need a need for an efficient system and method for inserting, delivering, and tracking advertisements in a media program. Referring now to the drawings, and more particularly to FIGS. 1 through 9, where similar reference characters denote corresponding features consistently throughout the figures, there are shown preferred embodiments.

FIG. 1 illustrates system view of an advertisement inserting and tracking system 100 according to an embodiment herein. The advertisement inserting and tracking system 100 includes a user interacting with a user device 102, a load balancer 104, a manifest server 106, an advertisement manager 108, a program content 110, a content security manager 112, a security token 114, an advertisement slots obtaining module 116, a live advertisement transcoder 118, a database 120, a geo-location database 122, a license server 124, one or more third party advertisement servers 126, and a publisher's CDN or a streaming server 128. A user requests the program content 110 (e.g., a media program) using the user device 102. The advertisement inserting and tracking system 100 inserts advertisements at predetermined cue-points of the user request program content 110, delivers a broadcast content including the user request program content 110 and advertisements to the user device 102, and tracks whether users have viewed the advertisements which are inserted at the predetermined cue-points. In one embodiment, the user device 102 is a computer, a laptop, a mobile device, a gaming console, a television connected to a set-top-box, a smart TV, or any media player device 102B. In one embodiment, the program content 110 is a live program, a DVR stream or a video-on-demand.

In one embodiment, the program content 110 is split by the CDN or the streaming server 128 into multiple segments of sub-programs of predetermined durations (e.g., like 10 seconds), and each segment of sub-programs includes an associated URL (uniform resource locator). Thus, the program content 110 includes a plurality of URLs (uniform resource locators), and each URL is associated with a sub-program content of a predetermined period. For example, 5 minutes program content includes 30 segments of sub-programs, and each segment includes an associated URL (i.e., 30 URLs). Thus, the program content 110 includes 30 URLs, and each URL is associated with a sub-program content of 10 seconds. Similarly, the advertisement content (including one or more advertisements) is split into multiple segments of sub-advertisements (i.e. ad chunks), and each segment of ad chunks includes an associated URL. Thus, the advertisement content includes a plurality of URLs, and each URL is associated with an ad chunk (i.e. sub-advertisement content of a predetermined period).

The manifest server 106 creates a URL playlist by stitching URL's of the sub-programs with URL's of the ad chunks at one or more advertisement slots. In yet another embodiment, the playlist is updated in real-time with new program content URLs as and when new content is available at the manifest server 106. The user device 102 fetches the URL playlist from the manifest server 106 dynamically, obtains broadcast content associated with the URL playlist, and plays the broadcast content associated with each URL in the URL playlist sequentially.

In one embodiment, the manifest server 106 downloads at least a part of a first sub-program of the segments of sub-programs. The manifest server 106 extracts a starting timestamp associated with the first sub-program. The starting timestamp includes (a) a decode timestamp or a presentation timestamp which is extracted from a video packet of the first sub-program, or (b) a presentation clock reference which is extracted from an audio packet of the first sub-program. The manifest server 106 communicates the starting time of a first sub-program to the advertisement manager 108 for selecting an advertisement that completes streaming at the starting time to ensure a smooth transition from the advertisement to the first sub-program.

In another embodiment, the manifest server 106 downloads at least a part of each of the one or more sub-programs. The manifest server 106 extracts a starting timestamp associated with each of the sub-programs. The starting timestamp includes (a) a decode timestamp or a presentation timestamp which is extracted from a video packet of each of the sub-programs, or (b) a presentation clock reference which is extracted from an audio packet of each of the sub-programs. The manifest server 106 obtains a start time and an end time of an advertisement slot associated with the media program from the advertisement manager 108. The manifest server 106 creating a URL playlist by replacing a sub-program URL corresponding to a sub-program which is about to stream at the advertisement slot with at least one ad chunk URL. In an embodiment, the streaming server 128 splits the sub-program into a first split sub-program and a second split sub-program when the advertisement slot starts in between a start time and an end time of the sub-program. In an embodiment, the manifest server 106 adds a URL corresponding to the first split sub-program to the URL playlist, and replaces a URL corresponding to the second split sub-program with the at least one ad chunk URL. The manifest server 106 further replaces a URL corresponding to the first split sub-program with the at least one ad chunk URL, and adds a URL corresponding to the second split sub-program to the URL playlist.

In an embodiment, the manifest server 106 stitches the URL associated with the plurality of advertisements (I.e. segments of sub-advertisements/ad chunks) first followed by the URL associated with the program content 110 (i.e. segments of sub-programs) to create the URL playlist. In another embodiment, the manifest server 106 stitches URLs associated with advertisements in between URLs associated with the program content 110 to create the URL playlist.

The manifest server 106 receives URLs associated with the program content 110 in real-time. The content security manager 112 authenticates a reliability of a source of the program content 110 by verifying a security token 114 associated with each URL of the program content 110, or appends the unique user specific security token 114 to the content URLs in the outgoing playlist.

The advertisement manager 108 interacts with the manifest server 106, the live advertisement transcoder 118, the database 120, the geo-location database 122, the license server 124, and the third party advertisement servers 126. The advertisement manager 108 includes an advertisement slots obtaining module 116 to identify or obtain information on pre-defined cue start points (time where advertisements start), and pre-defined cue stop points (time where advertisements stop) of advertisement slots associated with the program content 110 (e.g., the media program). In other words, the advertisement slots obtaining module 116 obtains start time and end time of one or more advertisement slots associated the program content or media program 110. The advertisement slots obtaining module 116 communicates the pre-defined cue start points and the pre-defined cue stop points to the manifest server 106 for stitching advertisements between cue start point and cue stop points. The advertisement manager 108 includes an advertisements selecting module to select advertisements for delivering at the one or more advertisement slots within the media program.

The live advertisement transcoder 118 transcodes advertisements that are selected to stream to the user device 102 based on user parameters on the fly to match the program content 110 exactly so that a media player 102B switches to the advertisement smoothly without any discontinuities. This process includes matching major video and audio codec parameters like resolution, codec type, codec profile, audio sampling rate, number of audio channels and also internal parameters like number of reference frames, deblocking filter parameters, vui parameters etc. Also, in one embodiment, the transcoded advertisement is modified to match timestamps (e.g., presentation timestamp, decode timestamp, and presentation clock reference) so that a transition from content to advertisement is smooth.

The database 120 stores advertisers provided information including advertisement campaigns, and user targets in terms of parameters including targeted countries, regions, cities, zip codes, DMA regions, gender, age groups, platforms, content genres, time slots etc. The geo-location database 122 stores information that assists in identifying a location of a user who request for the program content 110.

When the media player 102B receives a URL playlist with advertisement URLs, the media player 102B starts requesting the advertisement manager 108 for multiple advertisement segments one after another. When the advertisement manager 108 receives a first request from the media player 102B, the advertisement manager 108 collects various parameters related to the user. For example, obtaining an IP address of the user provides an exact location of the user, and a user agent of the user device 102 provides a device platform, OS type and version that the user is streaming on. The advertisement manager 108 further obtains demographics information associated with the user, and compares user parameters with target parameters that are stored in the database 120 to obtain one or more advertisements that are targeted to the user. The manifest server 106 creates a URLs playlist associated with the targeted advertisements and URLs of the program content 110. In case of advertisement exchanges, the advertisement manager 108 requests multiple advertisement exchange servers with the user parameters to receive advertisements in the form of VAST tags. This is a standard xml format which gives the details of the advertisement including ad name, ad URL, ad duration, various tracking URLs etc. The license server 124 provides subscription for publishers for a predetermined period of time or predefined number of ad impressions. In one embodiment, the advertisement server 108 obtains URLs associated with advertisements from the third party advertisement servers 126.

In one embodiment, in case of a pre-roll advertisement in which one or more advertisements start to stream before streaming requested program content, the manifest server 106 creates a URL playlist by stitching URLs associated with one or more advertisements followed by URLs associated with the program content 110. The manifest server 106 prepares one or more advertisement playlists which start with one or more advertisement URLs to serve advertisement segments depending on the length of advertisement and one or more latest program content URLs. The manifest server 106 communicates the advertisement playlists one after other as the user device 102 receives and streams the advertisements sequentially. In one embodiment, in the URL playlist, the advertisement URLs and URLs of the program content 110 are separated by a discontinuity flag that enables the video player 102B to know discontinuity between subsequent videos. In another embodiment, the manifest server 106 downloads small part of each program content segment to extract start timestamps including a decode timestamp (DTS), a presentation timestamp (PTS) from a first video packet, and a presentation clock reference (PCR) from first audio packet. The manifest server 106 appends the start timestamps to advertisement URLs at the advertisement manager 108, so that, the advertisement manager 108 could modify appropriate timestamps to advertisement segments to be delivered based on length of advertisements and segment number of the advertisements. This allows timestamps to flow smoothly from advertisements to the program content 110 and viewer doesn't see any discontinuity in the video segments. The manifest server 106 ensures the media player 102B streams all advertisement URLs at the user device 102. The advertisement manager 108 interacts with the manifest server 106 when each advertisement segment is served to the user device 102, so that, the manifest server 106 could serve the next ad playlist in the sequence until reaching an original content playlist.

In another embodiment, in case of mid-roll advertisements, in which one or more advertisements start to stream at pre-defined cue points while content is streaming, the manifest server 106 creates a playlist by stitching URLs associated with advertisements in between URLs associated with the program content 110. The manifest server 106 downloads small part of each program content segment to extract start timestamps including a decode timestamp (DTS), a presentation timestamp (PTS) from first video packet, and a presentation clock reference (PCR) from first audio packet. The manifest server 106 receives cue start points and cue end points from the advertisement slots obtaining module 116 as and when manifest server 106 detects ad breaks in the source feed. The manifest server 106 identifies URLs of the program content 110 that are to be replaced with advertisement URLs. In one embodiment, the manifest server 106 identifies URLs of the program content 110 that are to be replaced by comparing start timestamp of the program content 110 with an incoming cue timestamp to arrive at a content URL where a program content timestamp is more than or equal to cue start and less than or equal to cue stop.

For example, a program content includes a plurality of URLs including URL100 and its corresponding timestamp (time at which a video associated with the URL100 is to be streamed) is 1010 to 1020, URL101 and its corresponding timestamp is 1020 to 1030, URL102 and its corresponding timestamp is 1030 to 1040, URL103 and its corresponding timestamp is 1040 to 1050, and URL104 and its corresponding timestamp is 1050 to 1060. The incoming cue timestamp of an advertisement (e.g., 10 seconds Ad) to be streamed is 1040 to 1050. The manifest server 106 compares and identifies a program content URL (i.e., 1040 to 1050) where a program content timestamp is more than or equal to cue start and less than or equal to cue stop. The manifest server 106 replaces program content URL103 with an advertisement URL which in turn points mid-roll advertisements to the video player 102B. In one embodiment, advertisement URLs carries all the parameters necessary to serve the advertisements which match exactly with content which is being served before the advertisement break. These include all the timestamps such as PTS, DTS, PCR, along with content segment ID, a content segment duration, and advertisement break ID, etc.

In one embodiment, for a frame accurate advertisement insertion, the advertisement manager 108 downloads the program content segment which contains packets matching with or closest to the cue start timestamp. From the above example, the incoming cue timestamp of an advertisement (e.g., 5 seconds Ad) to be streamed is 1045 to 1050. The advertisement manager 108 downloads a program content segment associated with a URL103 since the program content segment contains packets matching with a cue start timestamp (i.e., 1045). The manifest server divides the program content segment into a first partial segment (1040 to 1045) and a second partial segment (1045 to 1050). A URL associated with the first partial segment is added to a content playlist, whereas the second partial content (1045 to 1050) is replaced by a URL associated with the advertisement of 5 seconds, and added to the playlist. Splitting of program content segment ensures the media player 102B switches from content to advertisement at exactly the point where advertisement break starts. Similarly, the content segment containing a packet having timestamp equal to or closes to the cue stop is divided into two parts at the refresh frame (I frame) and second part of the content is added to the content playlist. At the same time, cue stop is passed on to the advertisement manager 108, so that, the advertisement manager 108 in turn cuts the ad segment near the cue stop packet and streams only the partial ad segment. This ensures that the transition between last segment of ad and immediate content segment is smooth as well as accurate to the given cue stop.

In one embodiment, when a volume of users requesting program content is increasing, the advertisement segments are obtained from the publisher's CDN or streaming servers 128 instead of the advertisement manager 108. Delivery of advertisements is optimized by delivering transcoded smoothened advertisements through CDN so that further requests for the same advertisements from a same advertisement spot could be done through CDN which could be really quicker for end users and allows the advertisement manager 108 to handle a large number of users. The load balancer 104 assists with a plurality of manifest servers 106 and a plurality of advertisement managers 108 when there is a huge traffic in requesting and delivering media content to end users.

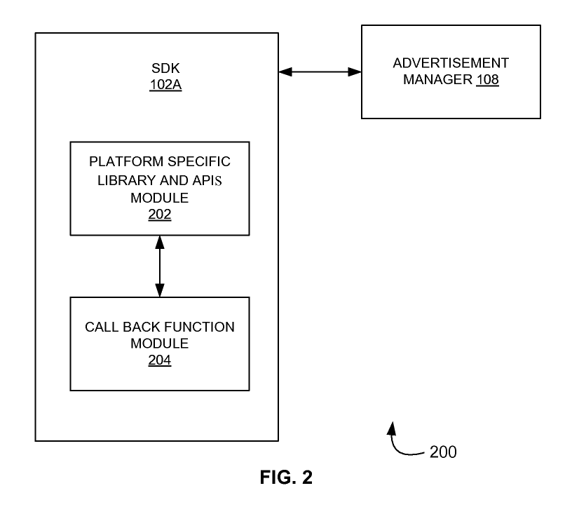

With reference to FIG. 1, FIG. 2 illustrates the advertisement inserting and tracking system 100 for tracking delivery and playback of advertisements according to an embodiment herein. In one embodiment, tracking delivery and playback of advertisements with advertisers is achieved based on Software defined kit (SDK) 102A. In another embodiment, tracking delivery and playback of advertisements with advertisers is achieved based on a playlist which is created at the manifest server 106. The SDK 102A is integrated with the media player 102B. The SDK 102A includes (i) a platform specific library and APIs module 202, and (ii) a call back function module 204. The platform specific library and APIs module 204 receives playback details such as video URL, current playback progress, current stream timestamp etc., from the media player 102B. The media player fires the call back function module 206 when the media player 102B receives an ID3 packet inside advertisement segments. In one embodiment, the ID3 packet includes a message which describes an advertisement segment ID, break ID etc. In another embodiment, the ID3 packet is inserted to the advertisement segments or ad chunks by an advertisement delivery server while transcoding the advertisements. When the call back function is fired, the SDK 102A receives the ad identifier details and sends the ad identifier details to the advertisement manager 108, so that, advertisement manager 108 can map the segment ID, break ID with the actual ad details obtained through the vast response. The SDK 102A then receives advertisement campaign details by sending the video URL, the playback details, the timestamp and the ID3 message. In one embodiment, the SDK is triggered based on an ID3 packets inside the one or more ad chunks at various locations corresponding to at least one of (a) start, (b) 25%, (c) 50%, (d) 75%, and (e) 100% duration of the advertisements. In another embodiment, the ID3 packet is inserted to the one or more ad chunks or advertisement segments by an advertisement delivery server while transcoding the advertisements. In yet another embodiment, the advertisement campaign details includes (i) a list of inserted advertisement names, (ii) duration of advertisements, (iii) a start and stop timestamp for each advertisements, and (iv) various tracking URLs which are derived from the VAST tag associated with advertisements. In another embodiment, the tracking URLs are requested on achieving certain events like start of an advertisement, 25%, 50%, 75% of the playback and completion of the playback. Other tracking URLs include events on the playback content like pause, resume, mute etc. When a user clicks on an advertisement while the advertisement is being played, the playback is paused and the user is redirected to a concerned webpage as directed by the VAST tag. In one embodiment, the advertisement also includes tracker URL which is requested by the SDK 102A.

Playlist based tracking of advertisements delivery and playback involves inserting tracker URLs inside a URL playlist which is delivered to the media player 102B. In one embodiment, placing of the tracker URLs depends on advertisements duration and advertisements segment size. The tracker URLs for start, 25%, 50%, 75% and completion of the ad are placed among the content URLs at various places such that they are requested as and when the part of the content is played back on the user device. In one embodiment, the manifest server 106 creates the URL playlist by stitching the tracker URLs along the URLs of the ad chunk at the one or more advertisement slots.

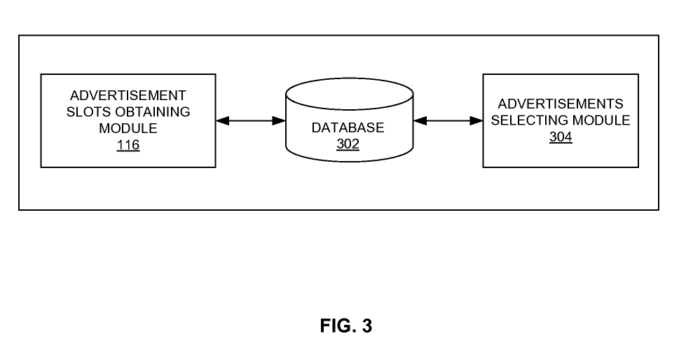

With reference to FIG. 1, FIG. 3 illustrates an exploded view of an advertisement manager 108 of FIG. 1 according to an embodiment herein. The advertisement manager 108 includes a database 302, the advertisement slot obtaining module 116, and an advertisements selecting module 304. The database 302 stores the advertisement slot obtaining module 116, and the advertisements selecting module 304. The advertisement slot obtaining module 304 is configured to obtain the start time and the end time of one or more advertisement slots associated with the program content or media program 110. The advertisement slots obtaining module 116 communicates the start time and the end time of one or more advertisement slots to the manifest server 106 for stitching advertisements in between the start time and the end time of one or more advertisement slots. The advertisements selecting module 304 is configured to select advertisements for delivering at the one or more advertisement slots within the program content or media program 110. In one embodiment, the selected advertisements are delivered at one or more advertisement slots within the program content 110 (e.g., the media program) through the streaming server 128, instead of the advertisement manager 108. The selected advertisements are cached for a plurality of users on the one or more same advertisement slots with same target parameters.

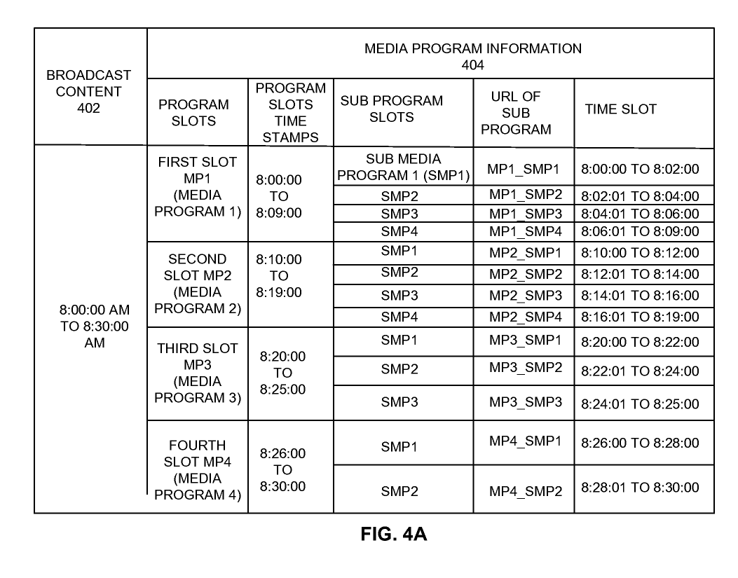

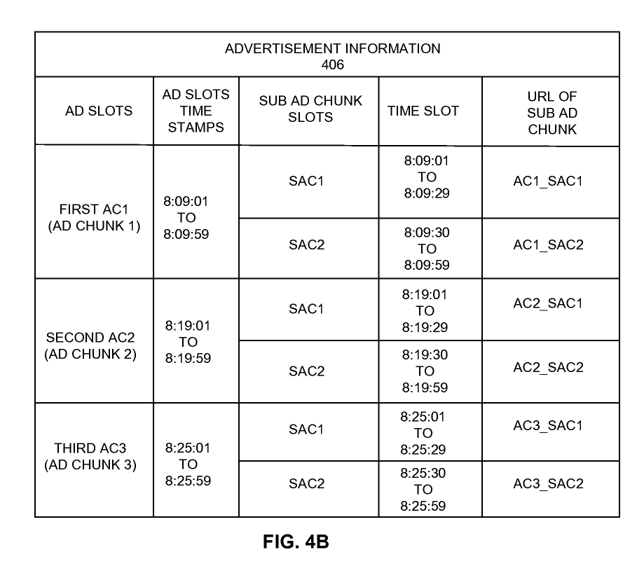

FIGS. 4A and 4B are an exemplary table views illustrating splitting a program content 110 and an advertisement content of FIG. 1 according to an embodiment herein. The exemplary table view includes a broadcast content 402, a media program information 404, and an advertisement information 406. The broadcast content 402 is broadcasted at the time period of 8:00:00 AM to 8:30:00 AM. The media program information 404 includes a program slots, a program slots timestamps, a sub program slots, an URL of sub programs, and a time slots. The program slots include a first slot media program (MP1), a second slot media program (MP2), a third slot media program (MP3), and a fourth slot media program (MP4). In one embodiment, the broadcast content 402 is subdivided into four predetermined time intervals to obtain program slots. The program slots timestamps include a predetermined timestamps for each program slots. The timestamp for the first slot media program is 8:00:00 AM to 8:09:00 AM. The timestamp for the second slot media program is 8:10:00 AM to 8:19:00 AM. The timestamp for the third slot media program is 8:20:00 AM to 8:25:00 AM. The timestamp for the fourth slot media program is 8:26:00 AM to 8:30:00 AM. The first slot media program is subdivided into four sub program slots that is a sub media program 1 (SMP1), a sub media program 2 (SMP2), a sub media program 3 (SMP3), and a sub media program 4 (SMP4). The each sub media program includes the URLs of predetermined time intervals. Similarly the second slot media program, the third slot media program, and the fourth slot media program are subdivided into one or more sub program slots, and each sub program slots includes the URLs of predetermined time intervals.

The advertisement information 406 includes an advertisement slots, an ad slots timestamps, a sub ad chunk slots, a time slot, an URL of sub ad chunk. The ad slots includes a first ad chunk (AC1), a second ad chunk (AC2), a third ad chunk (AC3), and a fourth ad chunk (AC4). The ad slots timestamps includes the predetermined timestamps for each ad chunks (i.e. the first ad chunk, the second ad chunk, the third ad chunk, and the fourth ad chunk). The timestamp for first ad chunk is 8:09:01 AM to 8:09:59 AM. The timestamp for second ad chunk is 8:19:01 AM to 8:19:59 AM. The timestamp for third ad chunk is 8:25:01 AM to 8:25:59 AM. The first ad chunk is subdivided into two sub ad chunk at predetermined time intervals. Each sub ad chunk includes the URLs of predetermined time intervals. Similarly the second ad chunk, and the third ad chunk are subdivided into one or more sub ad chunks, and each sub ad chunks includes the URLs of predetermined time intervals.

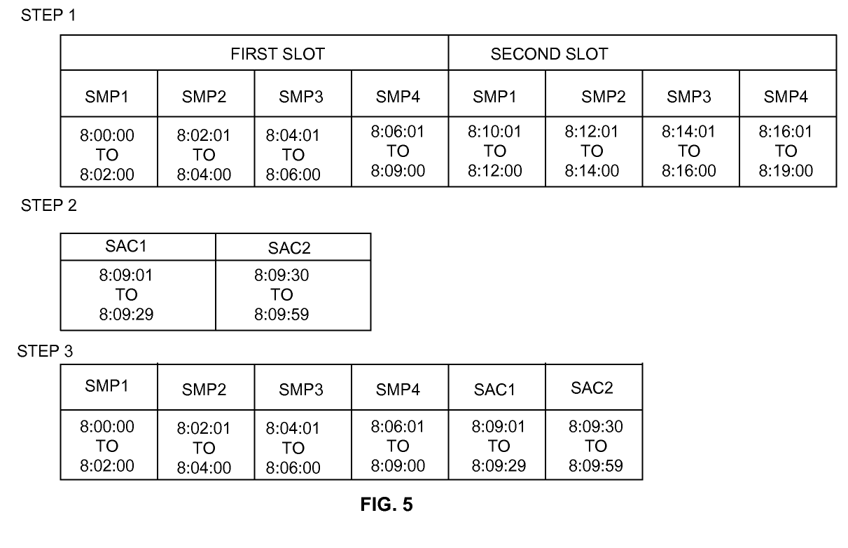

With reference to FIGS. 4A and 4B, FIG. 5 is a table view illustrating inserting a mid-roll advertisement content into a program content 110 of FIG. 1 according to an embodiment herein. In step 1, the media program is subdivided into one or more sub media programs (i.e SMP1, SMP2, SMP3, and SMP4) corresponding to the program slots. In step 2, the ad chunk is subdivided into two sub ad chunk at predetermined time intervals. In step 3, the manifest server 106 (i) identifies the locations of sub media programs, and sub ad chunk, (ii) receives the URLs associated with the media program, and ad chunk, and (iii) stitches URLs associated with advertisements in between URLs associated with the media program (mid-roll) to create the URL playlist. Ordinary person skilled in the art known that, similarly the advertisement URL 8:19:01 to 8:19:59 and 8:25:01 to 8:25:59 are stitched in between URLs associated with the media program to create the URL playlist.

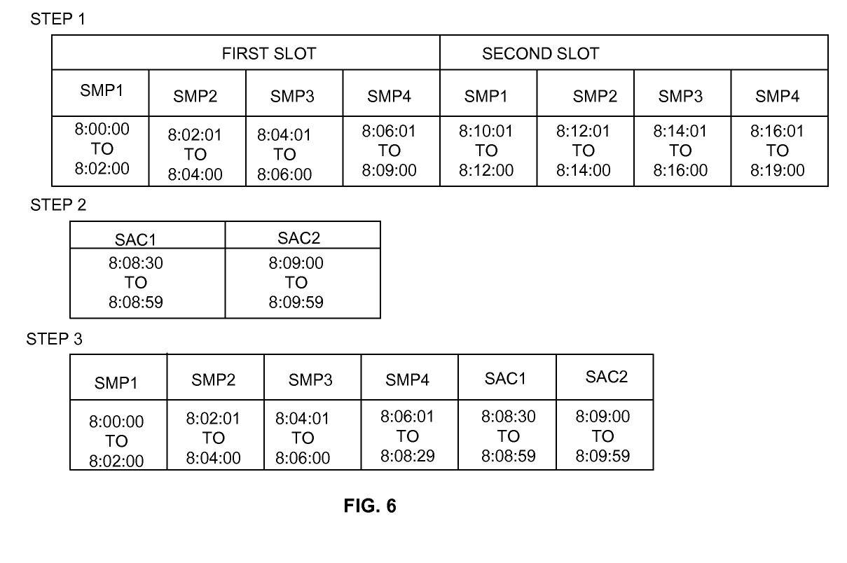

With reference to FIGS. 4A and 4B, FIG. 6 is a table view illustrating inserting a pre-roll advertisement content into a program content 110 of FIG. 1 according to an embodiment herein. In step 1, the media program is subdivided into one or more sub media programs (i.e. SMP1, SMP2, SMP3, and SMP4) corresponding to the program slots. In step 2, the ad chunk is subdivided into two sub ad chunk at predetermined time intervals. In step 3, the manifest server 106 (i) identifies the locations of sub media programs, and sub ad chunk, (ii) receives the URLs associated with the media program, and ad chunk, and (iii) stitches URLs associated with advertisements in between URLs associated with the media program (pre-roll) to create the URL playlist. Ordinary person skilled in the art known that, similarly the advertisement URL 8:19:01 to 8:19:59 and 8:25:01 to 8:25:59 are stitched in between URLs associated with the media program in a pre-roll manner as like step 2 to create the pre-roll URL playlist.

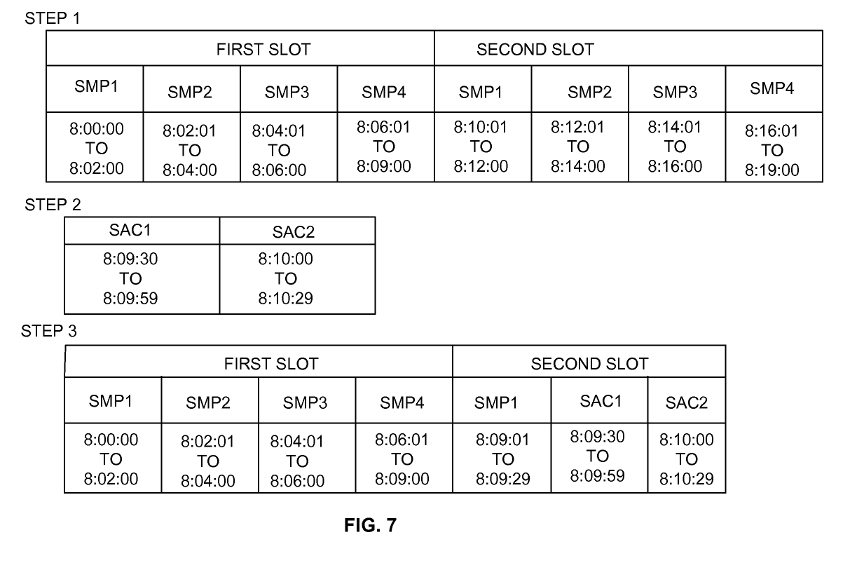

With reference to FIGS. 4A and 4B, FIG. 7 is a table view illustrating inserting a post-roll advertisement content into a program content 110 of FIG. 1 according to an embodiment herein. In step 1, the media program is subdivided into one or more sub media programs (i.e. SMP1, SMP2, SMP3, and SMP4) corresponding to the program slots. In step 2, the ad chunk is subdivided into two sub ad chunk at predetermined time intervals. In step 3, the manifest server 106 (i) identifies the locations of sub media programs, and sub ad chunk, (ii) receives the URLs associated with the media program, and ad chunk, and (iii) stitches URLs associated with advertisements in between URLs associated with the media program (post-roll) to create the URL playlist. Ordinary person skilled in the art known that, similarly the advertisement URL 8:19:01 to 8:19:59, and 8:25:01 to 8:25:59 are stitched in between URLs associated with the media program in a post-roll manner as like step 2 to create the URL playlist.

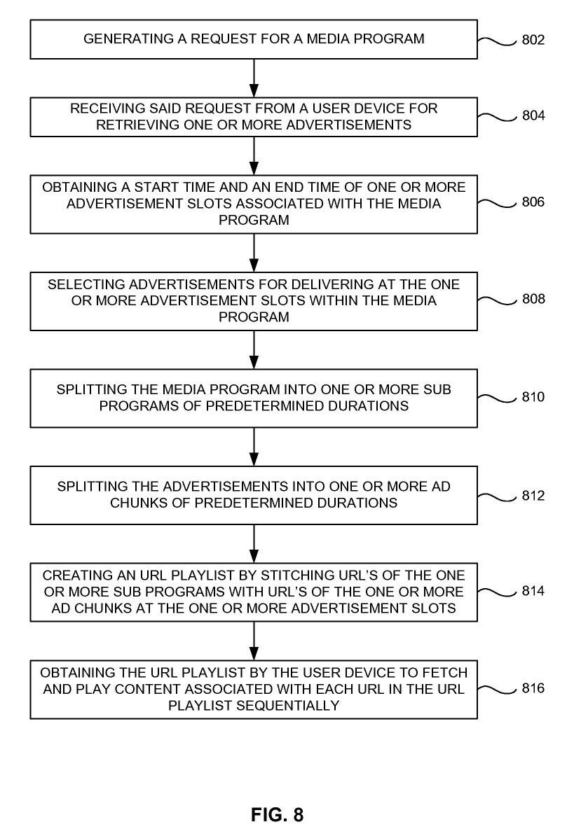

FIG. 8 is a flow diagram illustrating a method of inserting advertisement into a program content 110 and tracking a delivery of the advertisement using the advertisement inserting and tracking system 100 of FIG. 1 according to an embodiment herein. At step 802, a user requests the program content 110 using the user device 102. In one embodiment, the program content 110 is a live program, a dvr stream or a video-on-demand. At step 804, the advertisement manager 108 receives a first request from the user device 102 (e.g., a media player 102B). At step 806, the advertisement slots obtaining module 116 obtains a start time and an end time of one or more advertisement slots associated with the program content or media program 110. At step 808, advertisements selecting module 304 selects advertisements for delivering at the one or more advertisement slots within the program content 110. At step 810, the program content 110 is split by the CDN or the streaming server 128 into multiple segments of sub-programs with approximately fixed length (e.g., like 10 seconds), and each segment includes an associated URL (uniform resource locator). Thus, the program content 110 includes a plurality of URLs (uniform resource locators), and each URL is associated with a sub-program content of a predetermined period. At step 812, the advertisement content (including one or more advertisements) split by the streaming server 128 into multiple segments of sub-advertisements, and each segment includes an associated URL. Thus, the advertisement content includes a plurality of URLs, and each URL is associated with a sub-advertisement content of a predetermined period. At step 814, the manifest server 106 creates a URL playlist by stitching URL's of the sub-programs with URL's of the sub-advertisements or ad chunks at one or more advertisement slots. The URL playlist is updated in real-time with new program content URLs as and when new content is available at the manifest server 106. At step 816, the user device 102 (a) obtains the URL playlist from the manifest server 106, and (b) fetches and plays content associated with each URL in the URL playlist sequentially.

In one embodiment, the method further includes the following steps: (i) downloading at least a part of a first sub-program of the segments of sub-programs; (ii) extracting a starting timestamp associated with the first sub-program; and (iii) communicating the starting time of the first sub-program to the advertisement manager for selecting an advertisement that completes streaming at the starting time to ensure a smooth transition from the advertisement to the first sub-program. The starting timestamp may include (a) a decode timestamp or a presentation timestamp which is extracted from a video packet of the first sub-program, or (b) a presentation clock reference which is extracted from an audio packet of the first sub-program.

In another embodiment, the method further includes the following steps: (i) downloading at least a part of each of the segments of sub-programs; (ii) extracting a starting timestamp associated with each of the segments of sub-programs; (iii) obtaining a start time and an end time of an advertisement slot associated with the media program from the advertisement manager; and (iv) creating the URL playlist by replacing a sub-program URL corresponding to a sub-program which is about to stream at the advertisement slot with at least one ad chunk URL. The starting timestamp may include (a) a decode timestamp or a presentation timestamp which is extracted from a video packet of each of the plurality of sub-programs, or (b) a presentation clock reference which is extracted from an audio packet of each of the plurality of sub-programs.

In yet another embodiment, the method further includes the following steps: (i) stitching the URL associated with the advertisements first followed by the URL associated with the program content or media program 110 to create the URL playlist; and (ii) stitching URLs associated with advertisements in between URLs associated with program content to create the URL playlist. In yet another embodiment, the method further includes the step of (i) splitting the sub-program into a first split sub-program and a second split sub-program when the advertisement slot starts and ends in between a start time and an end time of the sub-program. In yet another embodiment, the method further includes the following steps: (i) adding a URL corresponding to the first split sub-program to the URL playlist; and (ii) replacing a URL corresponding to the second split sub-program with the at least one ad chunk URL. In yet another embodiment, the method further includes the following steps: (i) replacing a URL corresponding to the first split sub-program with the at least one ad chunk URL; and (ii) adding a URL corresponding to the second split sub-program to the URL playlist.

In an embodiment, the manifest server 106 creates the URL playlist by stitching the tracker URLs along with URLs of the ad chunk or sub-advertisement at the one or more advertisement slots. The user device 102 requests a tracker URL when a part of the program content or media program 110 is played back on the user device 102.

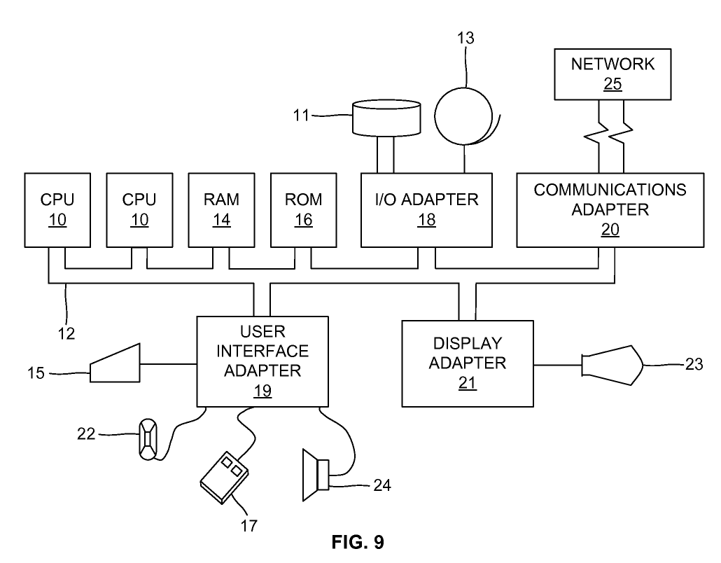

A representative hardware environment for practicing the embodiments herein is depicted in FIG. 9. This schematic drawing illustrates a hardware configuration of a computer architecture/computer system in accordance with the embodiments herein. The system includes at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The advertisement inserting and tracking system 100 inserts advertisements easily into various locations of a playlist. The advertisement inserting and tracking system 100 frequently checking the user device 102 whether the playlist is delivered or not. The advertisement inserting and tracking system 100 checks the user device 102 whether the user device 102 skips the playlist which contains advertisement segment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for inserting advertisements into a media program and tracking a delivery of said advertisements comprising:
(i) a user device that generates a request for said media program;
(ii) an advertisement manager that receives said request from said user device for retrieving a plurality of advertisements, wherein said advertisement manager comprises
(a) an advertisement slots obtaining module, executed by a processor of said advertisement manager, that obtains start time and end time of a plurality of advertisement slots associated with said media program; and
(b) an advertisements selecting module, executed by said processor, that selects advertisements for delivering at said plurality of advertisement slots within said media program, and
(iii) a streaming server that
a) splits said media program into a plurality of sub-programs of predetermined durations, wherein each of said plurality of sub-programs comprises an associated uniform resource locator (URL); and
b) splits said advertisements into a plurality of ad chunks of predetermined durations, wherein each of said plurality of ad chunks comprises an associated uniform resource locator (URL), and
(iv) a manifest server that creates a URL playlist by stitching URL's of said plurality of sub-programs with URL's of said plurality of ad chunks at said advertisement slots, wherein said user device (a) obtains said URL playlist from said manifest server, and (b) fetches and plays content associated with each URL in said URL playlist sequentially.

2. The system of claim 1, wherein said manifest server further:
(a) downloads at least a part of a first sub-program of said plurality of sub-programs;
(b) extracts a starting timestamp associated with said first sub-program, wherein said starting timestamp comprises (a) a decode timestamp or a presentation timestamp which is extracted from a video packet of said first sub-program, or (b) a presentation clock reference which is extracted from an audio packet of said first sub-program; and
(c) communicates said starting time of said first sub-program to said advertisement manager for selecting an advertisement that completes streaming at said starting time to ensure a smooth transition from said advertisement to said first sub-program.

3. The system of claim 1, wherein said manifest server further:
(a) downloads at least a part of each of said plurality of sub-programs;
(b) extracts a starting timestamp associated with each of said plurality of sub-programs, wherein said starting timestamp comprises (a) a decode timestamp or a presentation timestamp which is extracted from a video packet of each of said plurality of sub-programs, or (b) a presentation clock reference which is extracted from an audio packet of each of said plurality of sub-programs;
(c) obtains a start time and an end time of an advertisement slot associated with said media program from said advertisement manager; and
(d) creating said URL playlist by replacing a sub-program URL corresponding to a sub-program which is about to stream at said advertisement slot with at least one ad chunk URL.

4. The system of claim 1, wherein said manifest server further:
(a) stitches said URL associated with said plurality of advertisements first followed by said URL associated with said media program to create said URL playlist; and
(b) stitches URLs associated with advertisements in between URLs associated with program content to create said URL playlist.

5. The system of claim 3, wherein said streaming server splits said sub-program into a first split sub-program and a second split sub-program when said advertisement slot starts or ends in between a start time and an end time of said sub-program.

6. The system of claim 5, wherein said manifest server further:
(a) adds an URL corresponding to said first split sub-program to said URL playlist; and
(b) replaces an URL corresponding to said second split sub-program with said at least one ad chunk URL.

7. The system of claim 5, wherein said manifest server further:
(a) replaces an URL corresponding to said first split sub-program with said at least one ad chunk URL; and
(b) adds a URL corresponding to said second split sub-program to said URL playlist.

8. The system of claim 1, wherein said user device further comprises a SDK for tracking delivery and viewing of said advertisements at said user device, wherein said SDK is triggered based on an ID3 packet inside said plurality of ad chunks at various locations corresponding to at least one of (a) start, (b 25%, (c) 50%, (d) 75%, and (e) 100% duration of said advertisements.

9. The system of claim 8, wherein said ID3 packet is inserted to said plurality of ad chunks by an advertisement delivery server while transcoding said advertisements.

10. The system of claim 1, wherein said manifest server creates said URL playlist by stitching said tracker URLs along with URLs of said ad chunk at said advertisement slots, wherein said user device request a tracker URL when a part of said media program is played back on said user device.

11. The system of claim 1, wherein said selected advertisements are delivered at said plurality of advertisement slots within said media program through said streaming server instead of said advertisement manager, wherein said selected advertisements are cached for a plurality of users on said plurality of same advertisement slots with same target parameters.

12. A computer implemented method of inserting advertisements into a media program and tracking a delivery of said advertisements, said method comprising:
generating a request for said media program;
receiving said request from a user device for retrieving a plurality of advertisements;
obtaining a start time and an end time of a plurality of advertisement slots associated with said media program;
selecting advertisements for delivering at said plurality of advertisement slots within said media program;
splitting said media program into a plurality of sub-programs of predetermined durations, wherein each of said plurality of sub-programs comprises an associated uniform resource locator (URL);
splitting said advertisements into a plurality of ad chunks of predetermined durations, wherein each of said plurality of ad chunks comprises an associated uniform resource locator (URL);
creating an URL playlist by stitching URL's of said plurality of sub-programs with URL's of said plurality of ad chunks at said plurality of advertisement slots; and
obtaining said URL playlist by said user device to fetch and play content associated with each URL in said URL playlist sequentially.

13. The computer implemented method of claim 12, wherein said method comprises:
downloading at least a part of a first sub-program of said plurality of sub-programs;
extracting a starting times tamp associated with said first sub-program, wherein said starting timestamp comprises (a) a decode timestamp or a presentation timestamp which is extracted from a video packet of said first sub-program, or (b) a presentation clock reference which is extracted from an audio packet of said first sub-program; and
communicating said starting time of said first sub-program to said advertisement manager for selecting an advertisement that completes streaming at said starting time to ensure a smooth transition from said advertisement to said first sub-program.

14. The computer implemented method of claim 12, wherein said method comprises:
downloading at least a part of each of said plurality of sub-programs;
extracting a starting timestamp associated with each of said plurality of sub-programs, wherein said starting timestamp comprises (a) a decode timestamp or a presentation timestamp which is extracted from a video packet of each of said plurality of sub-programs, or (b) a presentation clock reference which is extracted from an audio packet of each of said plurality of sub-programs;
obtaining a start time and an end time of an advertisement slot associated with said media program from said advertisement manager; and
creating said URL playlist by replacing a sub-program URL corresponding to a sub-program which is about to stream at said advertisement slot with at least one ad chunk URL.

15. The computer implemented method of claim 12, wherein said method comprises:
stitching said URL associated with said plurality of advertisements first followed by said URL associated with said media program to create said URL playlist; and
stitching URLs associated with advertisements in between URLs associated with program content to create said URL playlist.

16. The computer implemented method of claim 14, wherein said method comprises:
splitting said sub-program into a first split sub-program and a second split sub-program when said advertisement slot starts and ends in between a start time and an end time of said sub-program.

17. The computer implemented method of claim 16, wherein said method comprises:
adding a URL corresponding to said first split sub-program to said URL playlist; and
replacing a URL corresponding to said second split sub-program with said at least one ad chunk URL.

18. The computer implemented method of claim 16, wherein said method comprises:
replacing a URL corresponding to said first split sub-program with said at least one ad chunk URL; and
adding a URL corresponding to said second split sub-program to said URL playlist.

19. A non-transitory program storage device readable by computer, and comprising a program of instructions executable by said computer to perform a method for inserting advertisements into a media program and tracking a delivery of said advertisements, said method comprising:
generating a request for said media program;
receiving said request from a user device for retrieving a plurality of advertisements;
obtaining a start time and an end time of a plurality of advertisement slots associated with said media program;
selecting advertisements for delivering at said plurality of advertisement slots within said media program;
splitting said media program into a plurality of sub-programs of predetermined durations, wherein each of said plurality of sub-programs comprises an associated uniform resource locator (URL);
splitting said advertisements into a plurality of ad chunks of predetermined durations, wherein each of said plurality of ad chunks comprises an associated uniform resource locator (URL);
creating an URL playlist by stitching URL's of said plurality of sub-programs with URL's of said plurality of ad chunks at said plurality of advertisement slots; and
obtaining said URL playlist by said user device to fetch and play content associated with each URL in said URL playlist sequentially.

20. The non-transitory program storage device of claim 19, further comprising:
downloading at least a part of a first sub-program of said plurality of sub-programs;
extracting a starting timestamp associated with said first sub-program, wherein said starting timestamp comprises (a) a decode timestamp or a presentation timestamp which is extracted from a video packet of said first sub-program, or (b) a presentation clock reference which is extracted from an audio packet of said first sub-program; and
communicating said starting time of said first sub-program to said advertisement manager for selecting an advertisement that completes streaming at said starting time to ensure a smooth transition from said advertisement to said first sub-program.
